(19) United States
(12) Patent Application Publication
(10) Pub. No.: US 2026/0117690 A1
(43) Pub. Date: Apr. 30, 2026

(54) MIXING DEVICE FOR MIXING A REACTION MEDIUM INTO A GAS STREAM, EXHAUST GAS PATH WITH SUCH A MIXING DEVICE AND INTERNAL COMBUSTION ENGINE

(71) Applicant: Rolls-Royce Solutions GmbH, Friedrichshafen (DE)

(72) Inventors: Igor Rogowski, Ravensburg (DE); Felix Notter, Konstanz (DE); Anton Reich, Kempten (DE); Andreas Holstein, Markdorf (DE)

(73) Assignee: Rolls-Royce Solutions GmbH, Friedrichshafen (DE)

(21) Appl. No.: 19/367,408

(22) Filed: Oct. 23, 2025

(30) Foreign Application Priority Data
Oct. 24, 2024 (DE) 102024131111.8
Sep. 10, 2025 (DE) 102025136556.3

(51) Int. Cl. F01N 3/28; B01F 23/213; B01F 25/10; B01F 25/314; F01N 3/20

(52) U.S. Cl. CPC F01N 3/2892; B01F 23/2132; B01F 25/103; B01F 25/3141; B01F 25/3143; F01N 3/206; B01F 2215/0422; F01N 2610/02; F01N 2610/1453

(57) ABSTRACT

A mixing device for mixing a reaction medium into a gas stream includes: a flow housing including an inlet wall with an inlet opening for the gas stream, an inflow direction of the gas stream enclosing an angle with a longitudinal axis; a swirling element, arranged in the flow housing opposite the inlet opening along the inflow direction and including sides facing toward and away from the inlet opening, the swirling element arranged such that (i) a first flow path for the gas stream is in the flow housing on the side facing toward the inlet opening and (ii) a second flow path for the gas stream is in the flow housing on the side facing away from the inlet opening; a metering device for metering the reaction medium into the flow housing and along a metering direction which is oblique to the inflow direction and to the longitudinal axis.

### CROSS REFERENCE TO RELATED APPLICATIONS

This claims priority to: (1) German patent application no. 10 2024 131 111.8, filed Oct. 24, 2024, which is incorporated herein by reference; and (2) German patent application no. 10 2025 136 556.3, filed Sep. 10, 2025, which is incorporated herein by reference.

### BACKGROUND OF THE INVENTION

### 1. Field of the Invention

The present invention relates to internal combustion engines with mixing devices.

### 2. Description of the Related Art

When mixing reaction media into gas streams by way of a mixing device, there is a requirement to achieve the most homogeneous mixing possible in the smallest possible assembly space, particularly over the shortest possible mixing distance. If additional requirements have to be met, for example, evaporating liquid reaction media or causing chemically active reaction media to react, for example, because a precursor of a reagent is introduced into the gas stream and is only converted into the reagent upon contact with the gas stream, the objective is also to achieve as complete a treatment as possible in terms of evaporation and/or reaction. Moreover, deposits of the reaction medium on the walls of such a mixing device should be avoided as much as possible. Furthermore, known mixing devices typically have an undesirable high flow resistance and thus counter pressure, and/or they cannot be improved in terms of their manufacturing costs.

What is needed in the art is a mixing device for mixing a reaction medium into a gas stream, an exhaust gas path for an internal combustion engine with such a mixing device and an internal combustion engine with such a mixing device or such an exhaust gas path, wherein the aforementioned disadvantages are at least reduced, optionally do not occur.

### SUMMARY OF THE INVENTION

The invention relates to a mixing device for mixing a reaction medium into a gas stream, an exhaust gas path for an internal combustion engine with such a mixing device, and an internal combustion engine with such a mixing device or such an exhaust gas path.

The present invention provides, in particular in a first aspect, a mixing device for mixing a reaction medium into a gas stream, wherein
the mixing device includes a flow housing having a longitudinal axis and an inlet wall with an inlet opening for the gas stream, wherein
the inlet opening is arranged relative to the longitudinal axis in such a way that an inflow direction of the gas stream encloses a first finite angle with the longitudinal axis, wherein
a swirling element is arranged in the flow housing opposite the inlet opening along the inflow direction, wherein
the swirling element is arranged in such a way that a first flow path for the gas stream is formed in the flow housing on a side of the swirling element facing the inlet opening, wherein a second flow path for the gas stream is formed in the flow housing on a side of the swirling element facing away from the inlet opening, wherein
the mixing device has at least one metering device for metering the reaction medium into the flow housing, and wherein
the at least one metering device is arranged and designed to meter the reaction medium along a metering direction which is arranged obliquely relative to the inflow direction and obliquely relative to the longitudinal axis.

The herein proposed mixing device can advantageously have an especially small installation space, in particular an especially short mixing path, while simultaneously providing excellent mixing and processing of the reaction medium by redirecting the gas flow from the inflow direction into a primary flow direction aligned along the longitudinal axis, wherein the gas flow is swirled by the swirling element, and by metering the reaction medium obliquely relative to the inflow direction and obliquely relative to the longitudinal axis. By providing the second flow path on the rear side of the swirling element, the swirling element can be heated very effectively and quickly by the typically hot gas stream on its rear side, thereby effectively preventing deposits of the reaction medium on the swirling element. In particular, the orientation of the metering direction obliquely to the longitudinal axis ensures that an at least hypothetical point of impact of the reaction medium on a wall of the mixing device is shifted toward the swirling element, so that potential drops of the reaction medium impact the swirling element and evaporate there, since the swirling element is advantageously heated by the portion of the gas stream flowing past the rear along the second flow path. At the same time, the inflowing gas stream flows along the inflow direction past the at least one metering device and carries along any droplets formed there. Moreover, the mixing device can be manufactured cost-effectively from simple housing parts, in particular sheet metal.

The metering direction is optionally aligned - at least with its components - against the inflow direction, that is, in particular obliquely relative to the inflowing gas stream.

The longitudinal axis is, in particular, an imaginary longitudinal axis of the flow housing. The longitudinal axis is in particular an axis of the longest extension of the flow housing and/or a symmetry- and/or central axis of the optionally at least substantially cylindrical flow housing. At the same time, the longitudinal axis defines the primary flow direction of the gas stream through the housing.

In one embodiment, the flow housing has an outlet wall with an outlet opening. In one arrangement, the outlet wall can be perpendicular to the longitudinal axis, or, in other words, an outlet normal vector of the outlet wall is aligned parallel to the longitudinal axis. In this case, an outflow direction of the gas flow through the outlet opening is optionally the same as the primary flow direction along the longitudinal axis. In another arrangement, the flow housing can have an additional flow redirection of the flow, wherein the outlet normal vector of the outlet wall and thus also of the outlet opening is oriented obliquely to the longitudinal axis.

The inflow direction of the gas stream is the direction in which the gas flow flows through the inlet opening into the flow housing; it is in particular the direction of an inlet normal vector of an imaginary inlet surface, defined by the inlet opening.

The swirling element is optionally designed as a swirling plate.

The first flow path is optionally a primary flow path for the gas stream, wherein the second flow path is a secondary flow path for the gas stream. This means, in particular, that a greater part, that is, a main portion, of the gas stream flows along the first flow path, with a smaller portion of the gas stream flowing along the second flow path. The second flow path serves thereby essentially to heat the back of the swirling element and is thus advantageously dimensioned so that this function is fulfilled with a view to effectively preventing deposits on the swirling element, wherein however optionally no greater portion of the gas stream is conducted along the second flow path than is necessary to fulfill this function. In contrast, the first flow path serves to process and intermix the reaction medium, so that as large a portion of the gas stream as possible is conducted along the first flow path without jeopardizing the function of effectively heating the swirling element. However, it is important that during operation of the mixing device, the gas flows along both flow paths - especially in a flow-parallel manner.

With the heating of the swirling element by the second flow path, the mixing device proposed here—in contrast to known measuring devices—does not primarily attempt to avoid wall contact between the reaction medium and the flow housing as far as possible. Rather, contact with the wall is controlled by at least extensively avoiding deposits by shifting the point of impact while simultaneously heating the swirling element. This advantageously results in the mixing device having an advantageously small installation space and a short mixing distance while at the same time effectively mixing and processing the reaction medium.

Without wanting to be bound to the theory, heating of the swirling element leads to the fact that when the reaction medium comes into contact with the swirling element, the Leidenfrost effect occurs, whereby the impacting droplets bounce off and are thus split into smaller droplets, which are transported further by the flow and are evaporated.

In the context of the present technical teaching, a reaction medium is understood to mean, in particular, a precursor substance for a reagent or a reagent which—in particular downstream of the mixing device—is brought to react with at least one component of the gas stream, optionally in a catalyst designed for this purpose. The catalyst can be, in particular, an oxidation catalyst or a catalyst for the selective catalytic reduction of nitrogen oxides (SCR catalyst). Accordingly, an oxidizing medium, or a medium which is oxidized with the reduction of components of the gas stream, or a reducing medium is optionally used as the reaction medium. In one arrangement, ammonia or an ammonia-containing solution, or an ammonia precursor substance or its solution, optionally urea or a urea-containing solution, in particular a urea-water solution, is metered into the mixing device by way of the metering device.

In one optional arrangement, the gas stream is an exhaust gas stream in particular an exhaust gas stream of an internal combustion engine.

In one embodiment, the at least one metering device is designed as a metering nozzle or a metering valve.

The swirling element is optionally arranged off-center relative to an imaginary center line of the inlet opening in the direction of the longitudinal axis. In particular, viewed in primary flow direction, it does not extend to a first vanishing point with an upstream end of the inlet opening; in contrast, on the downstream side, it extends beyond a second vanishing point with a downstream end of the inlet opening. In this way, in particular, a portion of the gas flow can enter into the second flow path—in particular, fluidically parallel to the first flow path—below or behind the swirling element.

A further development of the present invention provides that the swirling element is arranged so that the second flow path is fluidically parallel to the first flow path, so that the gas stream, originating from the inlet opening, is split into the first flow path and the second flow path. The gas stream therefore does not flow sequentially first through the first flow path and then through the second flow path, but is split originating from the inlet opening, into a first partial stream flowing along the first flow path and a second partial stream flowing along the second flow path, wherein the first partial stream and the second partial stream flow through the flow paths parallel to one another. Viewed from the inlet opening, the first flow path is located in front of (or above) the swirling element, and, viewed from the inlet opening, the second flow path is located behind (or below) the swirling element. The gas stream can pass proportionately behind the swirling element since, as explained above, it is arranged off-center relative to the imaginary center line of the inlet opening in the direction of the longitudinal axis, whereby, viewed in the direction of the primary flow, it does not extend on the upstream side to the first vanishing point with the upstream side end of the inlet opening, so that there remains a free space through which the gas can flow past the swirling element.

The design contributes advantageously to effective heating of the swirling element and to low flow resistance, and thus low counter pressure.

In one embodiment, the first flow path and the second flow path are merged upstream of the outlet opening of the flow housing. In other words, the first partial stream and the second partial stream are merged into a single stream upstream of the outlet opening and flow through the outlet opening together as the single stream.

In the context of the present technical teaching, the fact that a first location or a first element is arranged “upstream” of a second location or a second element is understood to mean that a volume element of the gas flow first flows past the first location or the first element and then past the second location or the second element.

Accordingly, the arrangement of the first location or the first element “downstream” of the second location or the second element is understood to mean that a volume element of the gas flow first flows past the second location or the second element and then past the first location or the first element.

A further development of the invention provides that the first angle is between 20° and 110°, optionally 90°. In these angular ranges, effective swirling of the gas flow upon impact with and contact with the swirling element can be advantageously achieved.

A further development of the invention provides that the direction of metering encloses a second angle of 95° to 115°, optionally 100° to 110°, optionally 102° to 106°, optionally 105°, with the inflow direction. Advantageously, metering occurs only partially counter to the inflow direction and, in particular in such a way that droplets of the reaction medium which formed at the metering device are detached and carried away or transported away by the gas flow.

Alternatively, or in addition it is provided that the metering direction together with the longitudinal axis—and thus the primary flow direction—enclose a third angle of 5° to 25°, optionally 10° to 20°, optionally 15°. In particular, in this angular range, an impact zone of the reaction medium on the swirling element is advantageously displaced, so that the reaction medium at least does not primarily impact the cooler wall of the flow housing, but rather the swirling element that is heated from its rear by the second flow path.

A further development of the invention provides that the swirling element is arranged and designed to generate a counter-rotating double swirl in the gas stream along the longitudinal axis—and thus along the primary flow direction. This allows for especially effective mixing of the reaction medium with the gas flow. Any remaining concentration differences in the reaction medium are advantageously compensated for by the contact of the two swirl flows with each other in an imaginary center plane of the double swirl.

In one embodiment, the swirling element is designed so that a radius of a single swirl flow of the double swirl—in particular of each individual swirl flow—is 35% to 60%, optionally 40% to 50%, optionally 42% to 48%, optionally 43% to 47%, envisaged 44% to 46%, optionally 45%, of a width dimension—measured perpendicular to the longitudinal axis—in particular a radius of the flow housing. In one arrangement, the radii of the two swirl flows are the same, in particular identical.

Alternatively, or in addition, the swirling element has a global curvature. It is therefore not only curved locally, for example in the region of individual deformations or depressions, but overall. In particular, the swirling element has a globally curved wall or is designed as a globally curved metal sheet. A radius of curvature of the swirling element can vary locally or can be globally constant. The radius of curvature—in the case of a local variation optional at any point of the swirling element—is optionally 20% to 80%, optionally 30% to 70%, optionally 35% to 60%, optionally 40% to 50%, optionally 42% to 48%, optionally 43% to 47%, envisaged 44% to 46%, optionally 45%, of the width dimension, in particular the radius of the flow housing measured perpendicular to the longitudinal axis.

Alternatively, or in addition, the swirling axes, that is, the rotational or rotary axes, of the swirl flows extend at least approximately parallel, optionally parallel to the longitudinal axis of the flow housing.

In the context of the present technical teaching, a counter-rotating double swirl is in particular to mean a flow form in which two swirl flows offset parallel to one another—each rotating about an axis of rotation, that is, arranged parallel to the longitudinal axis—are formed next to one another, wherein the axes of rotation of the swirl flows offset parallel to one another perpendicular to the longitudinal axis extend in the direction of the longitudinal axis, and wherein the directions of rotation of the swirl flows are opposite to one another, that is, one direction of rotation of one swirl flow is—viewed along the longitudinal axis, in the primary flow direction—mathematically negative, wherein the other direction of rotation of the other swirl flow is mathematically positive.

The swirling element is arranged and designed in particular so that it divides the interior of the flow housing into a volume region respectively for each of the two swirl flows.

The two swirl flows of the double swirl are optionally directed respectively from the inside to the outside. This means that the gas flow impacts the swirling element centrally inside the flow housing, is deflected radially outwards by the swirling element in the two swirl flows and flows laterally along the walls of the flow housing back towards the inlet opening—back upwards—thereby forming the respective swirl. In particular, when viewed along the longitudinal axis, in the primary flow direction, the direction of rotation of the left swirl flow is mathematically negative, and the direction of rotation of the right swirl flow is mathematically positive. This arrangement of the swirl flows is particularly advantageous with regard to counterpressure in the mixing device. This means that the mixing device designed in this way has a particularly low counterpressure.

In one embodiment, the swirling element is arranged and designed to generate the counter-rotating double swirl with a proportionally homogeneous distribution of the gas stream. In this manner, especially advantageous homogenization of the reaction medium with the gas flow can be achieved. In the context of the present technical teaching, a proportionally homogeneous distribution of the gas stream is understood in particular to mean that the two swirl flows carry an at least substantially identical, optionally identical, share of the total mass flow of the gas flow.

A further development of the invention provides that the swirling element, in a cross-sectional plane on which the longitudinal axis—and thus the primary flow direction—is perpendicular, has the shape of a rounded V—a V with curved, in particular inwardly bulging, that is, concave, legs or arms when viewed from outside the V. This represents a particularly suitable geometry of the swirling element for generating the double swirl. In particular, the rounded V opens along the imaginary inflow direction; in other words, the tip of the V—optionally likewise rounded or in particular roof-like sloped—points in the direction of the inlet opening while the arms of the V extend away from the inlet opening.

Thus, if one looks along the longitudinal axis in the direction of the primary flow of the gas stream and arranges the inlet opening at the top, the swirling element has the shape of an inverted, rounded V in the cross-sectional plane, with the tip pointing upwards or, in other words, the shape of a rounded L, particularly with arms that taper gently towards the sides—particularly concave—for example, like a child's line drawing of a flying bird, which is why the swirling element is also referred to as a “bird plate.” The swirling element optionally also has a geometry in which this cross-sectional shape is extruded perpendicular to the cross-sectional plane—in the direction of the longitudinal axis.

Alternatively, it is provided that the swirling element in the cross-sectional plane on which the longitudinal axis—and thus the primary flow direction—is perpendicular has the shape of a rounded W—a W with curved, in particular outwardly bulging, that is, convex, legs when viewed from outside the W. This also represents a particularly suitable geometry of the swirling element for generating the double swirl. In particular, the rounded W opens counter to the inflow direction; in other words, the inner, central tip of the W—optionally also rounded or in particular roof-like, sloped—points in the direction of the inlet opening, with the legs of the W also extending in the direction of the inlet opening. Therefore, if one looks along the longitudinal axis in the direction of the primary flow of the gas stream and arranges the inlet opening at the top, the swirling element has the shape of an upright, rounded W in the cross-sectional plane, with the tip and in particular the concave legs pointing upwards. The swirling element optionally also has a geometry in which this cross-sectional shape is extruded perpendicular to the cross-sectional plane—in the direction of the longitudinal axis.

A further development of the invention provides that the flow housing has at least one guide plate in the region of the inlet opening. The gas stream can therewith be advantageously guided in the region of the inlet opening into the interior of the flow housing, wherein it can be directed toward the swirling element, in particular to generate the double swirl.

In one embodiment, the flow housing has two guide plates opposite one another in the region of the inlet opening, perpendicular to the longitudinal axis—and thus perpendicular to the direction of the primary flow. In this way, the incoming gas flow can be directed in particular centrally onto the swirling element, so that the double swirl described above, rotating from the inside out, can be established.

In one embodiment, the at least one guide plate is designed as a single piece with the swirling element, optionally of the same material as the swirling element. The two guide plates are optionally designed as a single piece, optionally of the same material as the connecting element. It is particularly optional that the—extended—legs of the rounded W of the turbulence element form the two guide plates, wherein they are curved backward, in particular toward the center, in segments in the direction of the longitudinal axis.

In one embodiment, the swirling element together with the guide plates formed as a single piece is designed as a bent metal sheet.

In another embodiment, the at least one guide plate is a multipart component with the swirling element and is arranged in particular separately from the latter on the flow housing.

In one embodiment, the at least one guide plate is arranged such that it keeps an effective inlet cross-section for the gas stream constant in the direction of the longitudinal axis. Optionally, the two guide plates are arranged such that they maintain the effective inlet cross-section for the gas stream constant in the direction of the longitudinal axis. This advantageously results in a higher flow velocity of the gas stream and thus even further improved mixing, particularly compared to a configuration in which the guide plates narrow the effective inlet cross section in the direction of the longitudinal axis. A higher flow velocity can also help prevent the formation of a permanent wall film.

In one arrangement, the two guide plates are arranged and designed so that they increasingly narrow the effective inlet cross section for the gas stream in the direction of the longitudinal axis—and thus in the primary flow direction. This means, in particular, that the guide plates approximate each other along the longitudinal axis—viewed in the direction of the primary flow—or, that in other words, a distance between the guide plates measured perpendicular to the longitudinal axis decreases along the longitudinal axis. In this way, with the flow optimally aligned in the direction of the swirling element, sufficient space remains for the gas stream, so that the counter pressure of the mixing device is advantageously reduced, especially compared to a design in which the guide plates keep the effective inlet cross-section constant. In addition, the inflowing gas stream is advantageously accelerated by the narrowing, albeit to a lesser extent than in a design in which the inlet cross section is kept constant in the direction of the longitudinal axis.

By specifically designing the distance between the guide plates, optionally also the radii and/or contours of the guide plates, the flow velocity of the gas stream and, in particular, the intensity of the swirl flows can be influenced.

Alternatively, or in addition to the two guide plates, the flow housing has in the region of the inlet opening, one—in particular exactly one—centrally arranged guide plate as the at least one guide plate. This one guide plate is designed in particular as a distributor plate, which divides the inflowing gas stream—optionally halfway, that is, into equal proportions—into two partial flows. In this arrangement, a counter-rotating double swirl can be generated, wherein the directions of rotation are directed from the outside to the inside, and wherein the inflowing gas stream flows along the walls of the flow housing to outer extensions of the swirling element, from where it flows back centrally—upwards—in direction of the inlet opening.

In one embodiment, the flow housing has at least one impact element laterally to the longitudinal axis—that is, laterally to the primary flow direction—arranged such that droplets of the reaction medium entering a periphery of the flow housing impact the at least one impact element. These droplets can advantageously shatter into smaller droplets on the at least one impact element and can be evaporated more easily and quickly.

In one embodiment, the at least one impact element is arranged in the direction of the longitudinal axis—that is, in the primary flow direction—at the level of the swirling element.

One embodiment provides that the at least one impact element is designed as two ring segments located opposite one another, perpendicular to the longitudinal axis, that is, perpendicular to the primary flow direction, protruding radially into a flow region of the gas stream. This represents a particularly advantageous and effective design of the at least one impact element. In particular, two opposing ring segments respectively form one impact element.

Alternatively, or in addition, it is provided that the flow housing has two impact elements arranged one behind the other in the direction of the longitudinal axis, in other words, in the primary flow direction. Drops of the reaction medium which were not intercepted by the first front impact element can be intercepted by the second, rear impact element.

In one arrangement, each of the two impact elements, which are arranged one behind the other in the direction of the longitudinal axis, is respectively formed by two opposing ring segments, in other words, by a pair of ring segments each.

In one embodiment, one rear impact element, that is, the second impact element in primary flow direction, in particular of the two rear ring segments of the two ring segment pairs, protrudes radially further into the flow region than a front impact element of the impact elements. Thus, droplets of reaction medium not intercepted by the first, front impact element can be intercepted effectively by the second, rear impact element.

In the context of the present technical teaching, a radial direction is understood in particular to mean a direction that is perpendicular to the longitudinal axis.

Exactly one impact element can be provided, or more than two, in particular five, impact elements can be provided. Moreover, an impact element can have just one ring segment or more than two ring segments.

The at least one impact element can also be formed as one piece with the peripheral wall, in particular as a local deformation or reshaping of the peripheral wall, for example as a type of bellows, as in a compensator.

In one embodiment, the flow housing has a peripheral wall.

In one embodiment the peripheral wall is designed cylindrical, in particular as the outer surface of a circular cylinder. However, it is also possible for the peripheral wall to consist of a plurality of flat wall sections arranged at angles to one another.

A further development of the invention provides that the flow housing has at least one spacer element which is arranged and designed to keep the swirling element at a distance from the peripheral wall of the flow housing.

In one embodiment, the flow housing has a plurality of spacer elements which are arranged at a distance from one another, optionally distributed along the peripheral direction around the longitudinal axis and/or along the longitudinal axis.

The at least one spacer element connects the swirling element—and optionally the at least one guide plate—with the peripheral wall. The swirling element—and optionally the at least one guide plate—is attached to the peripheral wall via at least one spacer element.

Due to the distance between the swirling element—and in particular the at least one guide plate—on the one hand and the peripheral wall on the other hand provided by the at least one spacer element, an effective flow of the hot gas around the swirling element with the hot gas flow and thus a particularly effective heating of the swirling element—and optionally also of the at least one guide plate—can be guaranteed. Moreover, the at least one spacer element advantageously defines the distance between the peripheral wall and the swirling element, wherein the selection of the length of the at least one spacer element and thereby the distance can be used to adjust a distribution of the gas flow between the first and second flow paths and, at the same time, to specify the intensity of the rear heating of the swirling element.

A further development of the invention provides that the at least one spacer element is designed as a spacer pin. Alternatively, or in addition the at least one spacer element has a cylindrical or columnar shape. Moreover, alternatively or in addition, the at least one spacer element is designed as a spacer bolt.

In one arrangement, the at least one spacer element may be connected to the peripheral wall and the swirling element in a material-locking manner, for example by soldering or welding.

In particular, the swirling element, which is formed as one piece with the at least one guide plate, has a radial distance from the peripheral wall throughout—optionally defined by the at least one spacer element. Thus, it can be advantageously surrounded by part of the gas flow along its entire circumferential extent and also its longitudinal extent and can be heated particularly effectively by the gas flow.

A further development of the invention provides that the flow housing has the peripheral wall and a first end face, wherein the inlet opening is located on the peripheral wall as the inlet wall, and the at least one metering device is located on the first end face.

In particular, an interior of the flow housing is limited by the peripheral wall on the one hand and the first end face on the other hand.

The first end face optionally has an end face normal vector that is oriented obliquely relative to the longitudinal axis. The metering direction optionally points in the direction of the end face normal vector. In particular, the end face normal vector and the longitudinal axis enclose the third angle.

The swirling element is optionally arranged, in particular fastened, on the peripheral wall. Alternatively, or in addition, the at least one impact element is arranged, in particular fastened, on the peripheral wall.

In one embodiment, the flow housing has a second end face on which the outlet opening is arranged. In particular, the second end face is the outlet wall described above.

In one embodiment, the second end face is located opposite the first end face in the direction of the longitudinal axis, that is, in the direction of the primary flow.

A further development of the invention provides that the mixing device has two metering devices. On the one hand, in the case of larger gas mass flows, higher reaction medium flows can be advantageously metered in even with smaller metering devices, for example those used on trucks, while at the same time smaller reaction medium flows can be metered particularly accurately, in particular by switching off one of the metering devices.

In one embodiment, the two metering devices are arranged next to one other at the same height on the first end face.

In another embodiment the two metering devices are arranged relative to the swirling element in such a way that each metering device of the metering devices meters the reaction medium into a volume region of a swirl flow assigned to it of one of the two swirl flows of the double swirl. In other words, each of the two swirl flows has assigned to it respectively one of the metering devices for metering the reaction medium into the respective swirl flow.

Another embodiment provides that the mixing device has three metering devices.

On the one hand, in the case of larger gas mass flows higher reaction medium flows can be advantageously metered in even with smaller metering devices, for example those used on trucks, while at the same time smaller reaction medium flows can be metered particularly accurately, in particular by switching off one or two of the metering devices.

In one embodiment, the three metering devices are arranged symmetrically in the form of an isosceles triangle on the first end face.

A further development of the invention provides that the flow housing has at least one flow alignment element in the region of the inlet opening. Advantageously, an inconsistent, particularly turbulent gas flow can be homogenized or equalized by the at least one flow alignment element. In particular, a gas flow flowing from the turbine of an exhaust gas turbocharger can be aligned, particularly parallelized, by the at least one flow alignment element before it then again receives a defined swirl by the swirling element.

In one embodiment, the flow housing has at least two flow guide plates as the at least one flow alignment element.

In one embodiment, the at least two flow guide plates are arranged parallel to one another in a cross-sectional plane perpendicular to the inflow direction. Alternatively, or in addition the at least two flow guide plates are arranged obliquely, in particular orthogonally, to one another in the cross-sectional plane perpendicular to the inflow direction.

The present invention also provides in a second aspect an exhaust gas path for an internal combustion engine, which has at least one mixing device according to the invention or a mixing device according to one or more of the previously described embodiments. In connection with the exhaust gas path, the advantages arise in particular that were previously explained in connection with the mixing device.

Optionally, the exhaust gas path downstream of the mixing device has a catalyst, in particular an oxidation catalyst or a catalyst for selective catalytic reduction of nitrogen oxides (SCR catalyst).

In one embodiment, the exhaust gas path has an exhaust gas turbocharger upstream of the mixing device, in particular at least one turbine of an exhaust gas turbocharger.

The present invention also provides in a third aspect an internal combustion engine which has a mixing device according to the invention or a mixing device according to one or more of the previously described embodiments, or which has an exhaust gas path according to the invention or an exhaust gas path according to one or more of the previously described embodiments. In connection with the internal combustion engine those advantages arise in particular that were already explained above in connection with the mixing device or the exhaust gas path.

The internal combustion engine can optionally be arranged as a stationary internal combustion engine, in particular for driving a generator or a feed pump. Alternatively, the internal combustion engine can be arranged to drive a motor vehicle, in particular a commercial vehicle, for example a truck, a construction or building machine, a defense vehicle, a ship, or an aircraft.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a first view of a first design example of a mixing device;

FIG. 2 is a second view of the first design example of the mixing device according to FIG. 1;

FIG. 3 is a sectional view of the first embodiment of the mixing device along line A-A in FIG. 1;

FIG. 4 is a sectional view of the first design example of the mixing device along line B-B in FIG. 2;

FIG. 5 is a detailed view of detail D in FIG. 4;

FIG. 6 is a sectional view of the first design example of the mixing device along line C-C in FIG. 1;

FIG. 7 is a first view of a second design example of a mixing device;

FIG. 8 is a schematic side view of the second design example of the mixing device;

FIG. 9 is a sectional view of the second design example of the mixing device along line C-C in FIG. 7;

FIGS. 10A, 10B, 10C are representations of a third design example of the mixing device; and

FIG. 11 is schematic representation of a fourth design example of the mixing device.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

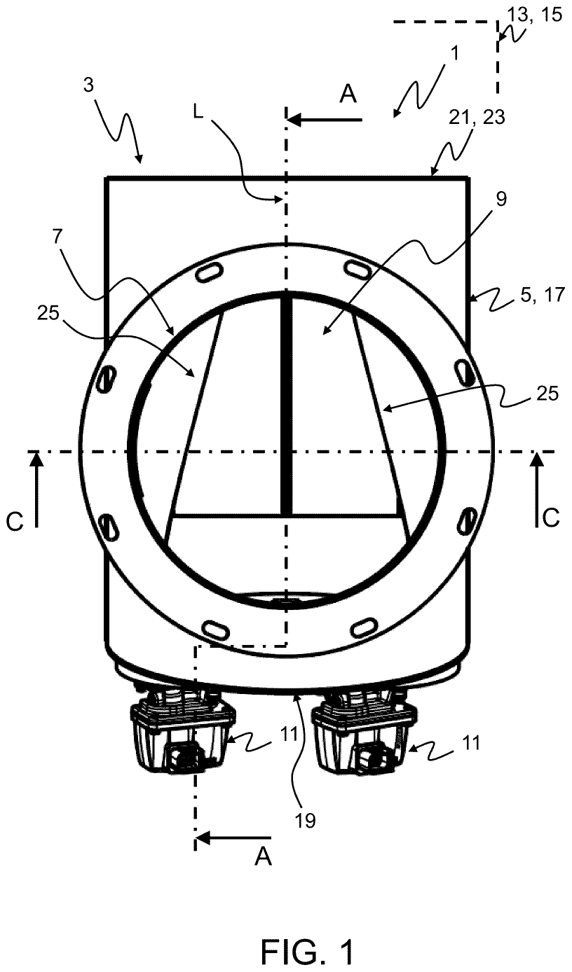

FIG. 1 shows a first view of a first design example of a mixing device 1.

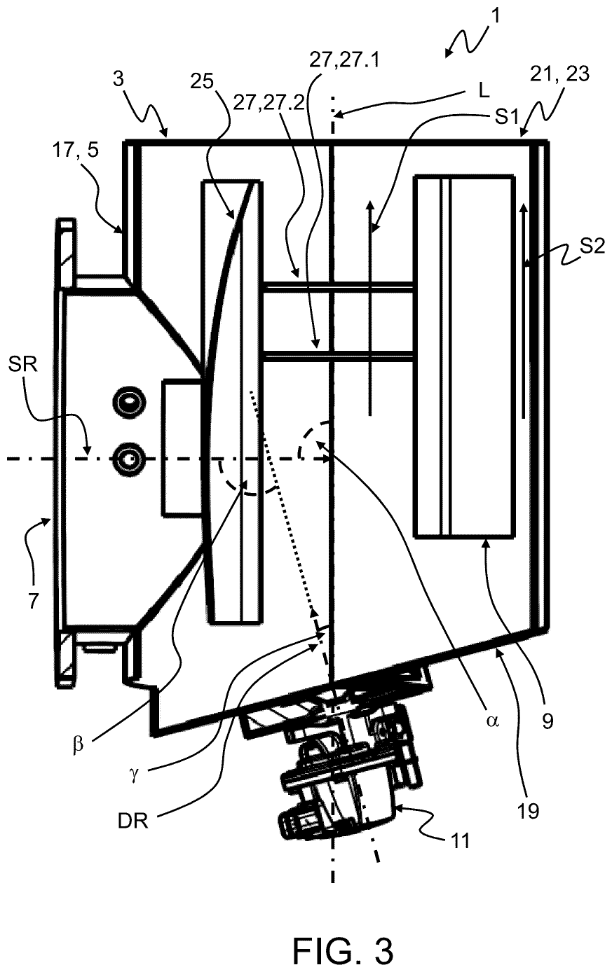

Mixing device 1 is designed for mixing a reaction medium into a gas stream and includes a flow housing 3 which has a longitudinal axis L and an inlet wall 5 with an inlet opening 7 for the gas stream. Longitudinal axis L defines a primary flow direction through flow housing 3. Inlet opening 7 is arranged relative to longitudinal axis L so that an inflow direction SR of the gas stream together with longitudinal axis L encloses a first finite angle α—see FIG. 3. In flow housing 3, opposite the inlet opening along inflow direction SR, a swirling element 9 is arranged which is optionally designed as a swirling plate. Swirling element 9 is arranged such that a first flow path S1—see FIG. 3—for the gas stream in flow housing 3 is formed on a side of swirling element 9 facing inlet opening 7, and a second flow path S2 (FIG. 3) for the gas stream in flow housing 3 is formed on a side of swirling element 9 facing away from inlet opening 7. Mixing device 1 also has at least one metering device 11 for metering the reaction medium into flow housing 3, wherein the at least one metering device 11 is arranged and designed to meter the reaction medium along a metering direction DR, which is arranged obliquely to inflow direction SR and obliquely to longitudinal axis L (FIG. 3).

The mixing device is optionally part of an exhaust gas path 13 of an internal combustion engine 15 and is arranged in the exhaust gas stream of internal combustion engine 15 upstream of a catalyst, in particular a catalyst for selective catalytic reduction of nitrogen oxides (SCR catalyst), wherein urea or a urea-containing solution, in particular a urea-water solution, is optionally metered into mixing device 1 by way of metering device 11 as the reaction medium.

Flow housing 3 optionally has a peripheral wall 17, which in the first design example shown here is cylindrical, in particular as the outer surface of a circular cylinder, and which forms inlet wall 5. Moreover, flow housing 3 has a first end face 19, wherein the at least one metering device 11 is arranged on first end face 19.

Swirling element 9 is optionally arranged on peripheral wall 17, in particular fastened, for example welded or soldered to it.

Flow housing 3 optionally has a second end face 21—in particular as an outlet wall—on which optionally an outlet opening 23 is arranged. Second end face 21 can be located opposite first end face 19 in the direction of longitudinal axis L.

In the first design example shown here, mixing device 1 has two metering devices 11, designed in particular as metering valves, which are arranged next to one another at the same height on first end face 19.

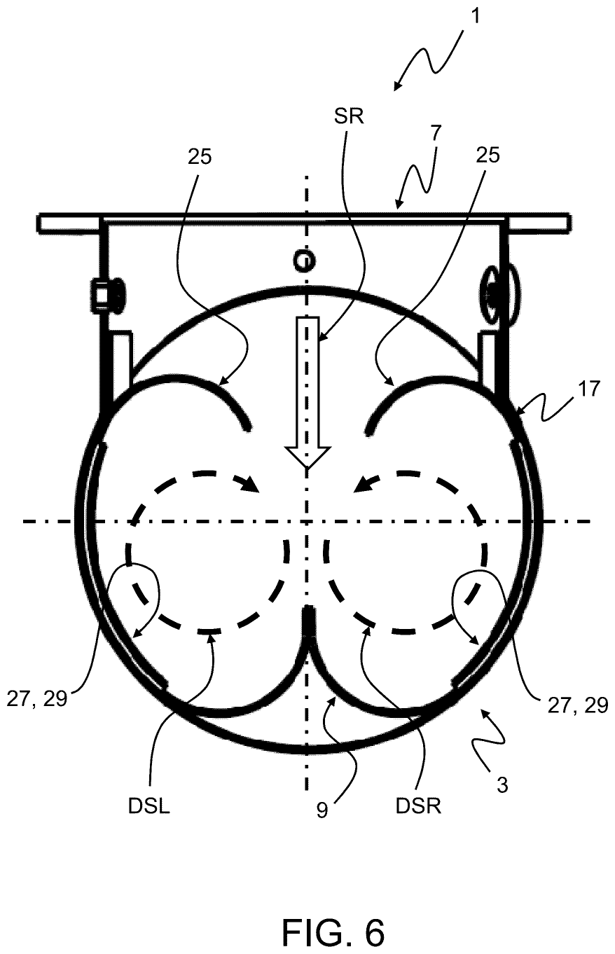

Flow housing 3 optionally has at least one guide plate 25 in the region of inlet opening 7, in this example, in particular two guide plates 25 opposite one another perpendicular to longitudinal axis L. The inflowing gas stream can thus be directed centrally onto swirling element 9, so that the double swirl rotating outward from the inside, as described below for FIG. 6, can be established.

The two guide plates 25 are in particular arranged and designed in such a way that they narrow an effective inlet cross-section for the gas stream in the direction of longitudinal axis L. In particular, guide plates 25 approximate each other along longitudinal axis L; in other words, the distance between guide plates 25 decreases along longitudinal axis L.

In the first design example, guide plates 25 are designed as a multipart unit with swirling element 9 and are arranged in particular separately from the latter on flow housing 3.

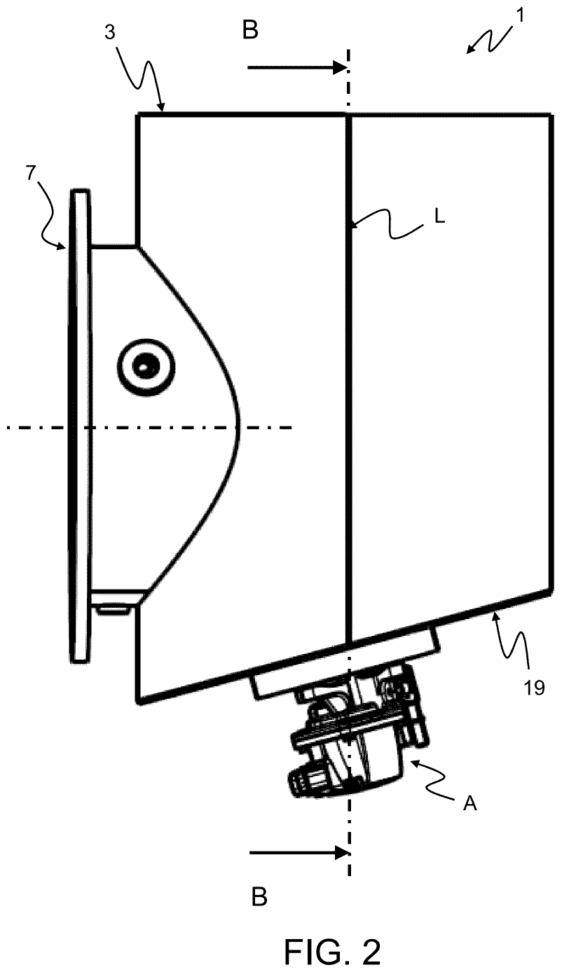

FIG. 2 shows a second view of the first design example of mixing device 1 according to FIG. 1.

For reasons of clarity, elements that appear multiple times in a drawing are provided with a reference symbol only once. Furthermore, identical, and functionally identical elements are provided with the same reference symbols in all figures, so reference is made to the preceding description in each case.

In this example, first end face 19, which is tilted relative to the vertical position of longitudinal axis L, is recognized in particular, with metering devices 11 arranged next to each other at the same height.

FIG. 3 represents a sectional view of mixing device 1 along line A-A in FIG. 1.

First angle α is 90° in the first design example shown here.

Metering direction DR encloses a second angle β, which is optionally 95° to 115°, optionally 100° to 110°, optionally 102° to 106°, optionally 105°.

Moreover, metering direction DR encloses a third angle γ of 5° to 25°, optionally 10° to 20°, optionally 15°, with longitudinal axis L. Metering direction DR points in particular in the direction of an end face normal vector of end face 19. In particular, the end face normal vector and longitudinal axis L enclose third angle γ.

First flow path S1 is, in particular, a primary flow path for the gas stream, while second flow path S2 simultaneously serves as a secondary flow path for the gas stream. Thus, a larger portion, which is a major portion, of the gas stream flows along first flow path S1, while a smaller portion of the gas stream flows along second flow path S2. Second flow path S2 essentially serves to heat the rear side of swirling element 9 and thus effectively prevents deposits of the reaction medium on swirling element 9, while first flow path S1 serves to process and mix the reaction medium with the gas stream.

Swirling element 9 is arranged, in particular, offset off-center relative to an imaginary center line of inlet opening 7 in the direction of longitudinal axis L; in particular, viewed in the primary flow direction, it does not extend on the upstream side to a first vanishing point with an upstream end of inlet opening 7; but on the downstream side, it extends beyond a second vanishing point with a downstream end of inlet opening 7. In this way, in particular, a portion of the gas flow can reach second flow path S2 below swirling element 9 (or, in the drawing, to the right of connecting element 9).

Flow housing 3 optionally has at least one impact element 27 arranged laterally to longitudinal axis L in direction of longitudinal axis L at the level of swirling element 9, in this example, two impact elements 27.1, 27.2 one behind the other along longitudinal axis L, which are arranged such that droplets of the reaction medium reaching a peripheral region of flow housing 3 strike impact elements 27. These droplets can advantageously shatter there into smaller droplets, which can be evaporated more easily and quickly.

Impact elements 27 are optionally arranged on peripheral wall 17, in particular fastened to it.

Swirling element 9 is arranged such that second flow path S2 is fluidically parallel to first flow path S1. The gas stream is thus divided, originating from inlet opening 7, into first flow path S1 and second flow path S2. Optionally, first flow path S1 and second flow path S2 are merged upstream of outlet opening 23.

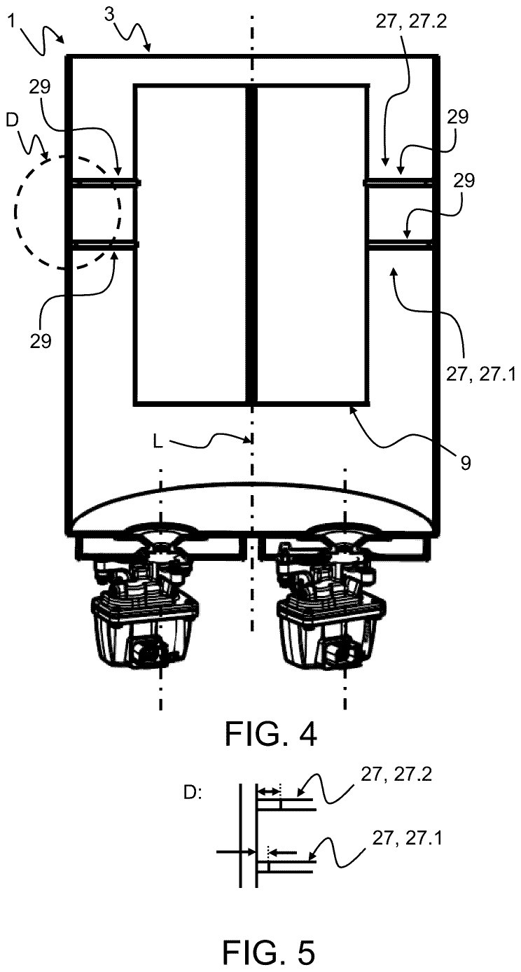

FIG. 4 represents a sectional view of mixing device 1 along line B-B in FIG. 2.

Impact elements 27 are each designed as ring segments 29 which are arranged in pairs opposite one another perpendicular to longitudinal axis L and project radially into a flow region of the gas stream.

FIG. 5 represents a detailed view of detail D from FIG. 4.

In one embodiment, rear impact element 27.2—that is the second one in the primary flow direction—projects radially further into the flow region than front impact element 27.1—that is, the first one in the primary flow direction.

FIG. 6 represents a sectional view of mixing device 1 along line C-C in FIG. 1.

Swirling element 9 has—in particular in the cross-sectional plane shown in FIG. 6, to which longitudinal axis L is perpendicular—the shape of an inverted, rounded V—a V with curved, in particular inwardly bulging, that is concave, legs or arms when viewed from outside the V. The rounded V opens along the—imaginary continued—inflow direction SR, that is the—rounded—tip of the V points in the direction of inlet opening 7 and thus opposite inflow direction SR, while the arms of the V extend away from inlet opening 7. Swirling element 9 also has an overall geometry that is extruded essentially perpendicular to the cross-sectional plane shown in FIG. 6—in the direction of longitudinal axis L.

Swirling element 9 is arranged and designed in particular to generate a counter-rotating double swirl in the gas stream along longitudinal axis L. Thus, especially effective mixing of the reaction medium with the gas flow can be achieved.

In this process, two parallel swirling flows DSL, DSR are formed next to each other, with the parallel swirl axes of rotation of the parallel swirl flows DSL, DSR extending in the direction of longitudinal axis L, and the directions of rotation of the swirl flows opposing each other. In particular, when viewed along the longitudinal axis, in the primary flow direction, that is, into the image plane, a first direction of rotation of the left swirl flow DSL in the figure is mathematically negative, while a different, second direction of rotation of the right swirl flow DSR in the figure is mathematically positive.

The two swirl flows DSL, DSR are optionally respectively directed from the inside outward. The gas flow inside flow housing 3 thus impacts swirling element 9 centrally, is deflected radially outward by the latter into the two swirl flows DSL, DSR, and flows laterally along the walls—here, outer wall 17—of flow housing 3 back toward inlet opening 7—back upwards—which creates the respective swirl.

Swirling element 9 is optionally arranged and designed to generate the counter-rotating double swirl with a proportionally homogeneous distribution of the gas stream.

The two metering devices 11 are arranged relative to swirling element 9 in particular in such a way that each metering device 11 meters the reaction medium into a respective swirl flow DSL, DSR assigned to it. In other words, each of the two swirl flows DSL, DSR is assigned one of the metering devices 11 for metering the reaction medium into the respective swirl flow DSL, DSR.

Swirling element 9 is optionally designed so that a radius of the respective swirl flow DSL, DSR is from 35% to 60%, optionally 40% to 50%, optionally 42% to 48%, optionally 43% to 47%, envisaged 44% to 46%, optionally 45%, of a width dimension—measured perpendicular to the longitudinal axis—in particular of a radius of flow housing 3.

Swirling element 9 optionally has a global curvature. A radius of curvature of the swirling element 9 can vary locally or be globally constant. The radius of curvature—in the case of a local variation optionally at any point on the swirling element—is optionally 20% to 80%, optionally 30% to 70%, optionally 35% to 60%, optionally 40% to 50%, optionally 42% to 48%, optionally 43% to 47%, envisaged 44% to 46%, optionally 45%, of the width dimension—measured perpendicular to the longitudinal axis—in particular the radius of the flow housing.

Alternatively, or in addition, the axes of rotation of the flows DSL, DSR extend at least approximately parallel, optionally parallel to longitudinal axis L of flow housing 3.

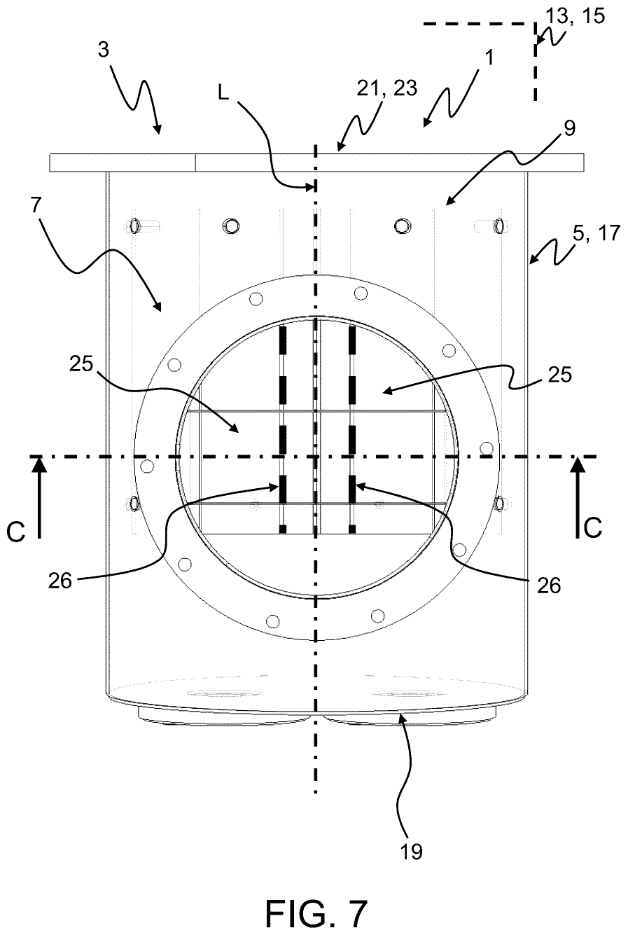

FIG. 7 represents a first view of a second embodiment of a mixing device 1, wherein peripheral wall 17 is transparent only for illustration purposes.

In the second design example, guide plates 25 are arranged so that they keep the effective inlet cross-section for the gas stream constant in the direction of longitudinal axis L. In particular, they form an inlet slot with parallel edges, as shown here by bold dashed lines 26.

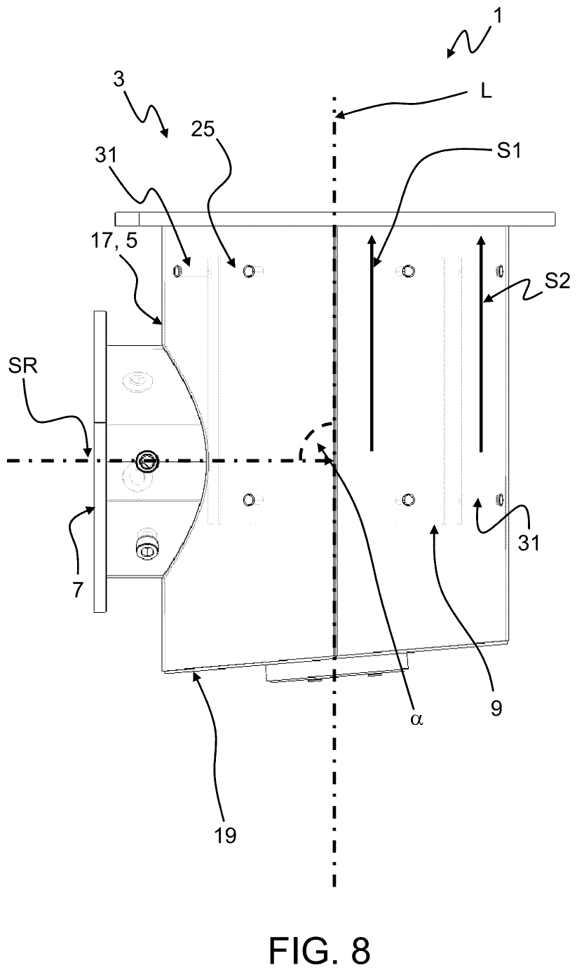

FIG. 8 represents a schematic side view of the second design example of mixing device 1, also with peripheral wall 17, transparent only for illustration purposes.

In the second design example, guide plates 25 are designed as one piece, optionally of the same material as connecting element 9, in particular as a bent metal sheet.

Flow housing 3 optionally has at least one spacer element 31, which is arranged and designed to keep swirling element 9 at a distance from the peripheral wall of flow housing 3. In particular, flow housing 3 has a plurality of spacer elements 31, which are herein distributed along the circumferential direction around longitudinal axis L and along longitudinal axis L, that is, at distance from one another. For the sake of clarity, only two of these spacer elements 31 are assigned reference identification. Spacer elements 31 connect swirling element 9—and at the same time also guide plates 25—to peripheral wall 17. In particular, swirling element 9, which is formed as one piece with guide plates 25, is fastened to peripheral wall 17 via spacer elements 31.

In this example, spacer elements 31 are designed as spacer pins or spacer bolts, in particular they have a cylindrical or columnar shape. They can be connected to peripheral wall 17 and swirling element 9 in a material-locking manner, for example, by soldering or welding.

In particular, swirling element 9, which is formed as one piece with guide plates 25, has a radial distance throughout to peripheral wall 17, as defined by spacer elements 31.

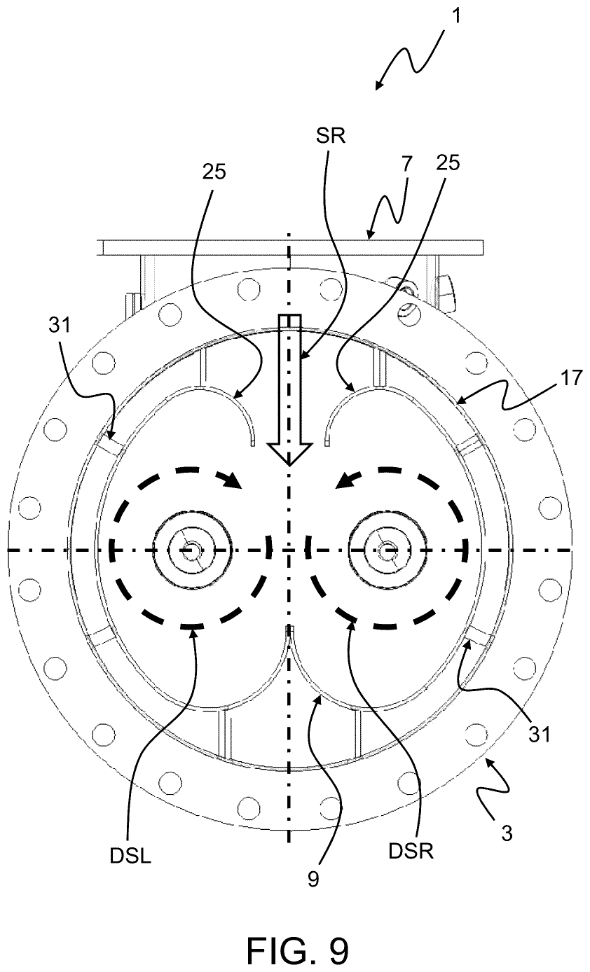

FIG. 9 represents a sectional view of the second design example of mixing device 1 along line C-C in FIG. 7.

In the second design example, swirling element 9 has the cross-sectional plane on which longitudinal axis L is perpendicular, has the shape of a rounded W—a W with curved, in particular outwardly bulging, that is, convex, legs when viewed from outside the W. In particular, the rounded W opens counter to inflow direction SR; in other words, the inner, central tip of the W—optionally also rounded or in particular roof-like, sloped—points in the direction of inlet opening 7, wherein the legs of the W also extend in the direction of inlet opening 7. Therefore, if one looks along longitudinal axis L in the direction of the primary flow of the gas stream, as in FIG. 9, and arranges inlet opening 7 at the top, swirling element 9 has the shape of an upright, rounded W in the cross-sectional plane, wherein the tip and the—in particular concave—legs point upwards. Swirling element 9 optionally also has a geometry in which this cross-sectional shape is extruded perpendicular to the cross-sectional plane—in the direction of longitudinal axis L.

The extended legs of the rounded W of swirling element 9 form especially optionally the two guide plates 25, wherein they are curved backward in particular towards the center, that is, in the direction of longitudinal axis L.

In the second design example, flow housing 1 optionally does not have any impact elements or, in other words, is free of impact elements.

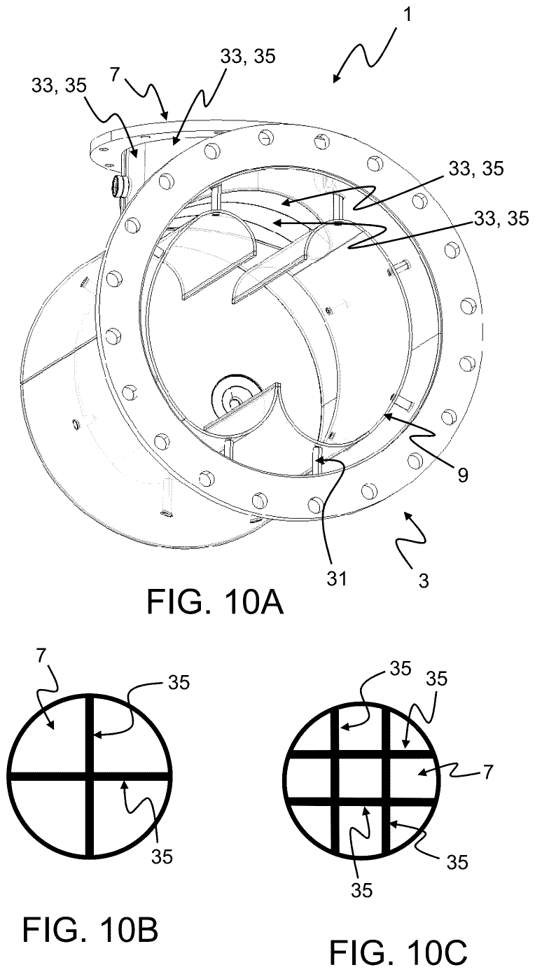

FIGS. 10A, 10B, 10C represent a third design example of mixing device 1, again, shown in section A (FIG. 10A) with peripheral wall 17 being transparent only for illustration purposes.

In the third design example, which otherwise corresponds to the second design example, flow housing 3 has at least one flow alignment element 33 in the region of inlet opening 7. This advantageously implements equalizing an inconsistent, particularly turbulent, gas flow.

In section A (FIG. 10A) it is shown that flow housing 3 has two flow alignment elements 33, namely two flow guide plates 35 aligned parallel to one another in a cross-sectional plane perpendicular to the inflow direction.

In section B (FIG. 10B) it is shown that the two flow guide plates 35 can also be arranged perpendicular to one another in the cross-sectional plane perpendicular to the inflow direction.

In section C (FIG. 10C) again, four flow guide plates 35 are shown, which are arranged in a grid arrangement in pairs parallel, and in pairs perpendicular, to each other.

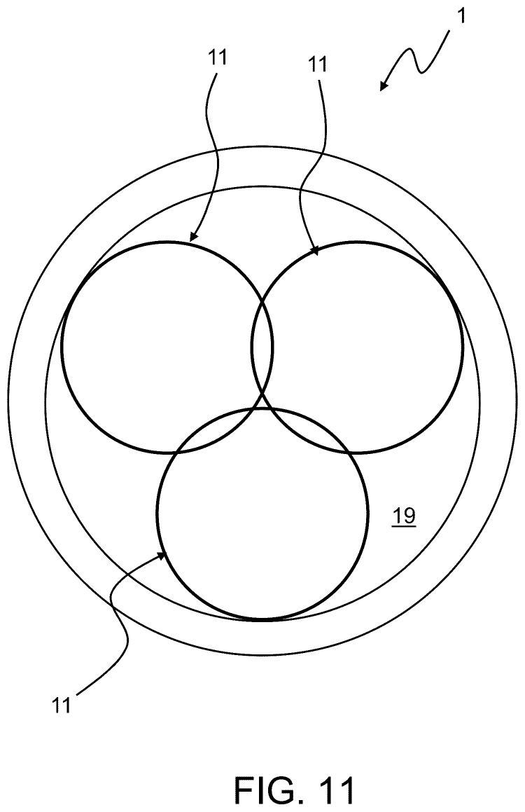

FIG. 11 represents a fourth design example of mixing device 1.

In the fourth design example, mixing device 1 has three metering devices 11. The three metering devices 11 are optionally arranged symmetrically in the form of an isosceles triangle on first end face 19.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A mixing device for mixing a reaction medium into a gas stream, the mixing device comprising:
a flow housing including a longitudinal axis and an inlet wall with an inlet opening for the gas stream, the inlet opening being arranged relative to the longitudinal axis such that an inflow direction of the gas stream encloses a first angle (α) with the longitudinal axis, the first angle being finite;
a first flow path;
a second flow path;
a swirling element, which is arranged in the flow housing opposite the inlet opening along the inflow direction, the swirling element including a side facing toward the inlet opening and a side facing away from the inlet opening, the swirling element being arranged such that (i) the first flow path for the gas stream is formed in the flow housing on the side of the swirling element facing toward the inlet opening and (ii) the second flow path for the gas stream is formed in the flow housing on the side of the swirling element facing away from the inlet opening;
at least one metering device configured for metering the reaction medium into the flow housing and for metering the reaction medium along a metering direction which is arranged obliquely relative to the inflow direction and obliquely relative to the longitudinal axis.

2. The mixing device according to claim 1, wherein the swirling element is arranged such that the second flow path is arranged fluidically parallel to the first flow path such that the gas stream, originating from the inlet opening, is split into the first flow path and the second flow path, wherein the first flow path and the second flow path are merged upstream of the outlet opening of the flow housing.

3. The mixing device according to claim 1, wherein the first angle (α) is between 20° and 110°.

4. The mixing device according to claim 1, wherein the metering direction at least one of:
(i) encloses a second angle (b) of 95° to 115° with the inflow direction; and
(ii) encloses a third angle (g) of 5° to 25° with the longitudinal axis.

5. The mixing device according to claim 1, wherein the swirling element is configured for generating a counter-rotating double swirl along the longitudinal axis.

6. The mixing device according to claim 1, wherein the swirling element is configured for generating a counter-rotating double swirl along the longitudinal axis with a proportionally homogeneous distribution of the gas stream.

7. The mixing device according to claim 1, wherein the swirling element, in a cross-sectional plane to which the longitudinal axis is perpendicular, is shaped as a V or a W.

8. The mixing device according to claim 1, wherein the swirling element, in a cross-sectional plane to which the longitudinal axis is perpendicular, is shaped as a rounded V or a rounded W.

9. The mixing device according to claim 1, wherein the mixing device includes a region of the inlet opening, wherein the flow housing includes at least one guide plate in the region of the inlet opening.

10. The mixing device according to claim 1, wherein the mixing device includes a region of the inlet opening, wherein the flow housing includes two guide plates in the region of the inlet opening, the two guide plates being opposite one another perpendicular to the longitudinal axis, wherein each of the two guide plates at least one of:
(i) is formed as a single piece with the swirling element or is formed as a multipart component with the swirling element; and
(ii) is configured for keeping constant or narrowing an effective inlet cross-section for the gas stream in a direction of the longitudinal axis.

11. The mixing device according to claim 1, wherein the flow housing includes a peripheral wall and at least one spacer element, which is configured for keeping the swirling element at a distance from the peripheral wall of the flow housing.

12. The mixing device according to claim 11, wherein the at least one spacer element is a spacer pin or a spacer bolt.

13. The mixing device according to claim 1, wherein the flow housing includes a peripheral wall and a plurality of spacer elements, which are configured for keeping the swirling element at a distance from the peripheral wall of the flow housing.

14. The mixing device according to claim 1, wherein the flow housing includes a peripheral wall and a first end face, wherein the inlet opening is located on the peripheral wall as the inlet wall, and the at least one metering device is arranged on the first end face.

15. The mixing device according to claim 1, wherein the at least one metering device includes two or three of the metering device, such that the mixing device includes two or three of the metering device.

16. The mixing device according to claim 1, wherein the mixing device includes a region of the inlet opening, wherein the flow housing in the region of the inlet opening includes at least one flow alignment element.

17. An exhaust gas path for an internal combustion engine, the exhaust gas path comprising:
at least one mixing device for mixing a reaction medium into a gas stream, the at least one mixing device including:
a flow housing including a longitudinal axis and an inlet wall with an inlet opening for the gas stream, the inlet opening being arranged relative to the longitudinal axis such that an inflow direction of the gas stream encloses a first angle (α) with the longitudinal axis, the first angle being finite;
a first flow path;
a second flow path;
a swirling element, which is arranged in the flow housing opposite the inlet opening along the inflow direction, the swirling element including a side facing toward the inlet opening and a side facing away from the inlet opening, the swirling element being arranged such that (i) the first flow path for the gas stream is formed in the flow housing on the side of the swirling element facing toward the inlet opening and (ii) the second flow path for the gas stream is formed in the flow housing on the side of the swirling element facing away from the inlet opening;
at least one metering device configured for metering the reaction medium into the flow housing and for metering the reaction medium along a metering direction which is arranged obliquely relative to the inflow direction and obliquely relative to the longitudinal axis.

18. An internal combustion engine, comprising:
(a) a mixing device for mixing a reaction medium into a gas stream, the mixing device comprising:
a flow housing including a longitudinal axis and an inlet wall with an inlet opening for the gas stream, the inlet opening being arranged relative to the longitudinal axis such that an inflow direction of the gas stream encloses a first angle (α) with the longitudinal axis, the first angle being finite;
a first flow path;
a second flow path;
a swirling element, which is arranged in the flow housing opposite the inlet opening along the inflow direction, the swirling element including a side facing toward the inlet opening and a side facing away from the inlet opening, the swirling element being arranged such that (i) the first flow path for the gas stream is formed in the flow housing on the side of the swirling element facing toward the inlet opening and (ii) the second flow path for the gas stream is formed in the flow housing on the side of the swirling element facing away from the inlet opening;
at least one metering device configured for metering the reaction medium into the flow housing and for metering the reaction medium along a metering direction which is arranged obliquely relative to the inflow direction and obliquely relative to the longitudinal axis; or
(b) an exhaust gas path for the internal combustion engine, the exhaust gas path including:
at least one mixing device for mixing a reaction medium into a gas stream, the at least one mixing device including:
a flow housing including a longitudinal axis and an inlet wall with an inlet opening for the gas stream, the inlet opening being arranged relative to the longitudinal axis such that an inflow direction of the gas stream encloses a first angle (α) with the longitudinal axis, the first angle being finite;
a first flow path;
a second flow path;
a swirling element, which is arranged in the flow housing opposite the inlet opening along the inflow direction, the swirling element including a side facing toward the inlet opening and a side facing away from the inlet opening, the swirling element being arranged such that (i) the first flow path for the gas stream is formed in the flow housing on the side of the swirling element facing toward the inlet opening and (ii) the second flow path for the gas stream is formed in the flow housing on the side of the swirling element facing away from the inlet opening;
at least one metering device configured for metering the reaction medium into the flow housing and for metering the reaction medium along a metering direction which is arranged obliquely relative to the inflow direction and obliquely relative to the longitudinal axis.
